(19) United States
(12) Patent Application Publication
(10) Pub. No.: US 2016/0254576 A1
(43) Pub. Date: Sep. 1, 2016

(54) BATTERY ARRANGEMENT

(71) Applicant: AIRBUS DEFENCE AND SPACE GMBH, Ottobrunn (DE)

(72) Inventor: Simon BURNS, Munich (DE)

(21) Appl. No.: 15/053,391

(22) Filed: Feb. 25, 2016

(30) Foreign Application Priority Data
Feb. 26, 2015 (EP) 15 000 555.1

(51) Int. Cl. H01M 10/48; B64G 1/42; B64D 27/24; H01M 10/0525; H01M 10/42

(52) U.S. Cl. CPC H01M 10/482; H01M 10/0525; H01M 10/486; H01M 10/4235; B64D 27/24; B64G 1/425; H01M 2220/20; B64C 2201/042

(57) ABSTRACT

A battery arrangement is provided that includes battery cells that are electrically connected to one another, wherein each of the battery cells includes individual electrochemical cells. Each of the battery cells is thermally insulated from the further battery cells of the plurality of battery cells. Each of the individual electrochemical cells includes a monitoring device. The monitoring device is configured to electrically disconnect the battery cell from the further battery cells if at least one measured value that is to be monitored by the monitoring device lies outside a predetermined value range.

### CROSS-REFERENCE TO RELATED APPLICATION

This application claims priority to EP 15 000 555.1 filed Feb. 26, 2015, the entire disclosure of which is incorporated by reference herein.

### TECHNICAL FIELD

Various embodiments relate in general to a battery arrangement and also to a vehicle having a battery arrangement.

### BACKGROUND

In vehicle construction, by way of example in automotive construction and aircraft construction, rechargeable batteries are being used ever more frequently for electrical drives, part drives or at least for supplying energy to electrical devices. Inter alia, various lithium-based rechargeable batteries are used since these comprise a relatively large specific energy.

In the case of various lithium-based rechargeable batteries having fluid or polymer electrolytes, it can be possible in certain circumstances that a thermal runaway can occur if special measures are not undertaken. Mechanical damage can lead by way of example to internal short circuits. The high currents that are flowing can lead in certain circumstances to the accumulator heating up. Housings that are embodied from synthetic material can by way of example melt and ignite. In certain circumstances, it is not possible to directly identify a mechanical defect. It is also possible for internal short circuits to occur a long time after the mechanical defect. Likewise, air and in particular air moisture can penetrate into the cell and produce chemical reactions as a result of damage to the exterior. A thermal load in the case of various lithium ion rechargeable batteries can cause the utilized separator to melt and thereby lead to an internal short circuit with a sudden release of energy (heating, igniting). A further danger can possibly be based on exothermic decomposition reactions of the cell chemicals in the case of an overload, in particular during the charging process.

In automotive construction and in particular in aircraft construction, particularly high safety requirements are placed on the utilized rechargeable batteries owing to the high amounts of energy that is installed.

### SUMMARY

Based upon this background, an object of the disclosure herein is to provide an improved battery arrangement.

This object is achieved with a device having features such as those disclosed herein wherein exemplary embodiments are illustrated. It is to be noted that the features of the exemplary embodiments of the devices also apply for embodiments of the application of the device and conversely.

A battery arrangement is provided that comprises a plurality of battery cells that are electrically connected to one another, wherein each of the battery cells comprises a plurality of individual electrochemical cells. Each of the battery cells is thermally insulated from the further battery cells of the plurality of battery cells. Each of the individual electrochemical cells comprises a monitoring device. The monitoring device is configured so as to electrically disconnect the battery cell from the further battery cells if at least one measured value that is to be monitored by the monitoring device lies outside a predetermined value range.

An object of the disclosure herein is to separate the battery cells of the battery arrangement from one another in a thermal manner. For the case that at least one of the individual electrochemical cells of the battery cells comprises a measured value that lies outside a predetermined value range, the entire battery cell is electrically disconnected from the further battery cells of the battery arrangement. Firstly, this has the advantage that by thermal separation no further individual electrochemical cells of the further battery cells are damaged. Furthermore, this has the advantage that in the case of a failure of one or also multiple battery cells, the further battery cells are still independently available. In the case of a failure of only a limited number of battery cells, the battery arrangement can still be used with a somewhat reduced performance.

The term “individual electrochemical cell” is to be understood as a preferably rechargeable energy storage device for electrical energy, also described as a secondary element. A battery cell comprises a plurality of individual electrochemical cells or secondary elements. The individual cells of the battery cell are preferably electrically connected to one another in series. Alternatively, the individual cells of a battery cell can also be connected to one another in parallel. The term “battery” is understood in general to mean a so-called rechargeable battery, in other words a battery that can be recharged. The monitoring device is preferably arranged in part on or at least near to the individual electrochemical cell, wherein the monitoring device is preferably at least in part arranged in such a manner that it is able to directly or indirectly ascertain or to receive the measured value that is to be monitored and relates to the individual electrochemical cell.

The term “thermal insulation” is to be understood as a thermal separation of the battery cells of the battery arrangement. In the extreme case, during a thermal runaway of an individual electrochemical cell, a pure thermal insulation based upon a pure thermal insulation that is dependent upon the material would possibly not be sufficient to protect the adjacent battery cells from damage.

A value range is defined by at least two values of a physical variable, by way of example temperature, voltage, current strength etc. It is preferred that the value range is determined by an upper and a lower value, in other words two different values. Alternatively, the value range can also be determined by an individual value and the information regarding whether the value range lies above or below this value.

In accordance with one embodiment, the battery cells are arranged spaced apart with respect to one another. The individual battery cells of the battery arrangement are preferably spaced apart with respect to one another in order to achieve an improved thermal separation. To be more precise, the multiple battery cells of the battery arrangement are arranged by way of example in different regions of a vehicle, by way of example an aircraft, a motor vehicle or the like. A better thermal insulation of the individual battery cells with respect to one another is achieved by battery cells being spaced apart with respect to one another. In the event of one or multiple individual electrochemical cells of a battery cell burning out, further battery cells of the battery arrangement that are spaced apart are consequently not affected.

In accordance with one embodiment, the monitoring device comprises an ascertaining unit that is configured so as to ascertain the measured value that is to be monitored and relates to the individual electrochemical cell. The ascertaining unit ascertains the measured value that is to be monitored and relates to the individual electrochemical cell. It is preferred that the ascertaining unit is arranged in such a manner that it is to be at least in part in thermal, electrical or another form of contact with the individual electrochemical cell, it is thereby possible to ascertain the measured value. By way of example, the ascertaining unit is arranged at least in part on or in the individual electrochemical cell or at least parts of the cell.

In accordance with one embodiment, the monitoring device comprises an evaluating device that receives the measured value that is ascertained by the ascertaining unit and determines whether the measured value lies outside the predetermined value range. In order to evaluate the measured value that is ascertained by the ascertaining unit, the ascertained measured value or, if multiple measured values are ascertained, the measured values is/are transmitted from the ascertaining unit to the evaluating device of the monitoring device. The evaluating device determines whether the ascertained measured value lies outside the predetermined value range. The predetermined value range, by way of example two preferably different temperature values, is stored by way of example in a storage device of the monitoring device or the evaluating device. The evaluating device compares by way of example the temperature value that is ascertained by the ascertaining unit with the stored temperature values in order to determine whether the ascertained temperature value lies within the value range that is defined by the two stored temperature values.

In accordance with one embodiment, the ascertaining unit comprises at least one temperature sensor for ascertaining the temperature of the individual electrochemical cell. In order to ascertain the temperature of the individual electrochemical cell, the ascertaining unit comprises by way of example a temperature sensor, by way of example a PTC sensor (temperature sensor having a positive temperature coefficient) or an NTC sensor (temperature sensor having a negative temperature coefficient). In order to ascertain the temperature of the individual electrochemical cell as precisely as possible, the temperature sensor is arranged as close as possible to the heat source, in other words in part or entirely on or in parts of the individual electrochemical cell.

In accordance with one embodiment, the monitoring device is configured so as to electrically disconnect the battery cell from the further battery cells of the plurality of battery cells if the temperature of the individual electrochemical cell that is ascertained by the temperature sensor lies outside a predetermined temperature range. In the event that by way of example the measured value that is ascertained by the ascertaining unit lies outside the predetermined measured range, this could indicate that one of the individual electrochemical cells of the battery cell is starting to burn-out. In order to reduce further damage, the monitoring device electrically disconnects this battery cell from the further battery cells of the battery arrangement.

In accordance with one embodiment, the monitoring device is configured so as to electrically disconnect the battery cell from the further battery cells if the ascertained temperature of the individual electrochemical cell lies above a predetermined temperature value. Should by way of example the measured value that is ascertained by the ascertaining unit lie above a predetermined temperature value, this could indicate that one of the electrochemical cells of the battery cell is starting to burn-out. Alternatively, only one individual value can be stored in the storage device and the value represents a threshold value for the temperature that is to be ascertained by the ascertaining device and relates to the individual electrochemical cell.

In accordance with one embodiment, each of the battery cells comprises at least one further ascertaining unit that comprises a voltage sensor for ascertaining the voltage that prevails at the battery cell. It is possible by the voltage sensor of the further ascertaining unit to ascertain by way of example a change in voltage, such as by way of example a voltage drop of the battery cell and the voltage drop could indicate by way of example the failure of one or multiple of the individual electrochemical cells of the battery cell. It is possible to prevent further damage to the battery arrangement or also to the battery cell itself in certain circumstances by electrically disconnecting the entire battery cell from the further battery cells of the battery arrangement.

In accordance with one embodiment, the at least one further ascertaining unit comprises a current sensor for ascertaining the current that prevails at the battery cell. It is possible by the current sensor of the further ascertaining unit to ascertain by way of example a drop in performance of the battery cell and the drop in performance could indicate by way of example the failure of one or multiple individual electrochemical cells of the battery cell. It is possible to prevent further damage to the battery arrangement or also the battery cell itself in certain circumstances by electrically disconnecting the entire battery cell from the further battery cells of the battery arrangement.

In accordance with one embodiment, the electrochemical cell is a lithium ion rechargeable battery. A lithium ion rechargeable battery or lithium rechargeable battery is a rechargeable battery based on lithium compounds in all three phases of the electrochemical cell. The reactive materials both in the negative electrode as well as in the positive electrode and also the electrolyte include lithium ions. In the case of various lithium ion rechargeable batteries having fluid or polymer electrolytes, a thermal runaway is possible if special protective measures are not undertaken. The effects during a thermal runaway of one or multiple individual electrochemical cells of a battery cell on the further battery cells of the battery arrangement are minimized by the battery arrangement described herein.

In accordance with one embodiment, the lithium ion rechargeable battery is a lithium sulphur rechargeable battery (Li—S). In the case of a lithium sulphur rechargeable battery, sulphur is generally used as a composite with carbon in the cathode. As a consequence, the electrode is sufficiently electrically conductive. The structural characteristics such as pore geometry and the specific surface of the carbon have a crucial effect on the usable sulphur proportion and thereby the specific capacity of the cathode. For the anode, generally lithium metal is used as a foil or coating. Based on the Li—S cells, it is possible to produce batteries having a clearly reduced weight whilst maintaining the same energy content and volume.

Furthermore, in order to achieve the object, a vehicle is provided that comprises at least one above described battery arrangement. The term “a vehicle” is to be understood as an airborne vehicle, a water-borne vehicle or a land-based vehicle.

In accordance with one embodiment, the plurality of the battery cells of the at least one battery arrangement is arranged distributed spaced apart with respect to one another over the vehicle. By way of example, the above described battery arrangement can be used in a vehicle in such a manner that the individual battery cells of the battery arrangement are arranged in different regions of the vehicle, by way of example an air-borne vehicle. A thermal insulation of the individual battery cells is achieved by spacing the battery cells apart with respect to one another. In the case of a thermal runaway of one or multiple individual electrochemical cells of a battery cell, the further battery cells of the battery arrangement are not affected.

In accordance with one embodiment, the vehicle is a flying apparatus. Alternatively, the vehicle can also be a motor vehicle, by way of example an automobile, or a water-borne vehicle, by way of example a ship. The term “flying apparatus” is to be understood as an airborne vehicle or more precisely as a device that flies or travels within the atmosphere of the earth.

In accordance with one embodiment, the flying apparatus is an unmanned aircraft such as a UAV (unmanned aerial vehicle). By way of example, the flying apparatus can be an unmanned light aircraft or ultralight aircraft. Alternatively, the flying apparatus can also be a manned aircraft.

In accordance with one embodiment, the flying apparatus is a high altitude platform (station) or a pseudo satellite or a so-called pseudolite. Pseudolite is a term that is combined from pseudo and satellite. A pseudo satellite is a terrestrial transmitter or a transmitter that is close to the earth and transmits signals that mimic the signals of a satellite. In the present form, the flying apparatus is used as a transmitter that is close to the earth (in comparison to a real satellite). Pseudo satellites are used for example in order to locally increase the measuring accuracy of satellite-aided navigation systems such as for example GPS. Pseudo satellites appear as additional satellites for a GPS receiver. Pseudo satellites are also used in order to distribute signals for satellite radio in cities. More precisely, pseudo-satellites assume inter alia tasks that in general are performed by satellites, yet have the advantage that the costs for a pseudo satellite are in general considerably smaller than for a real satellite. In particular, expensive costs are omitted for transporter rockets that are generally necessary in order to convey “real” satellites into orbit. The term “high altitude platform (station) (HAP(S))” is an umbrella term for quasi stationary, unmanned flying objects at a high altitude. A high altitude platform station can be used to monitor (traffic, events, weather) or at a corresponding altitude even for mobile radio communications without the delay associated with satellites.

By way of example, the above described battery arrangement can be used in a flying apparatus in such a manner that the individual battery cells of the battery arrangement are arranged in different regions of the flying apparatus. A thermal insulation of the individual battery cells is achieved by spacing the battery cells apart with respect to one another. In the case of a thermal runaway of one or multiple individual electrochemical cells of a battery cell, the further battery cells of the battery arrangement are not affected.

### BRIEF DESCRIPTION OF THE DRAWINGS

In the drawings, identical reference numerals relate in general to identical parts in the various views. The drawings are not necessarily to scale; value is placed instead in general on illustrating the principles of the disclosure herein. Various embodiments of the disclosure herein are described in the description hereinunder with reference to the following drawings, in the drawings:

FIG. 1 illustrates an embodiment of the battery arrangement;

FIG. 2 illustrates an embodiment of a monitoring device on an individual electrochemical cell;

FIG. 3 illustrates an embodiment of a battery cell;

FIG. 4 illustrates a conventional battery arrangement; and

FIG. 5 illustrates an aircraft having an embodiment of the battery arrangement.

The detailed description hereinunder makes reference to the attached drawings that explain specific details and embodiments in which the disclosure herein can be used.

### DETAILED DESCRIPTION

The word “exemplary” is used herein with the meaning of “being used as an example, case or illustration”. Each embodiment or design that is described herein as “exemplary” is not necessarily intended as preferred or advantageous with respect to other embodiments or designs.

Reference is made in the detailed description hereinunder to the attached drawings that form part of this description and in which specific embodiments are provided as an illustration in which the disclosure herein can be used. In this respect, terminology relating to direction such as “above”, “below”, to the front“, to the rear”, at the front“, at the rear” etc. are used in relation to the orientation of the described figure(s). Since components of embodiments can be positioned in a number of different orientations, the terminology relating to direction is used for the purposes of illustration and is in no way limiting. It is understood that other embodiments can be used and structural or logical changes can be made without departing from the protective scope of the present disclosure. It is understood that the features of the various exemplary embodiments that are described herein can be combined with one another unless specifically indicated otherwise. The detailed description hereinunder is therefore not to be considered limiting and the protective scope of the present disclosure is defined by the attached claims.

Within the scope of this description, the terms “connected”, “linked” and also “coupled” are used to describe both a direct as well as an indirect connection, a direct or indirect link and also a direct or indirect coupling. In the figures, identical or similar elements are provided with identical reference numerals as far as is expedient.

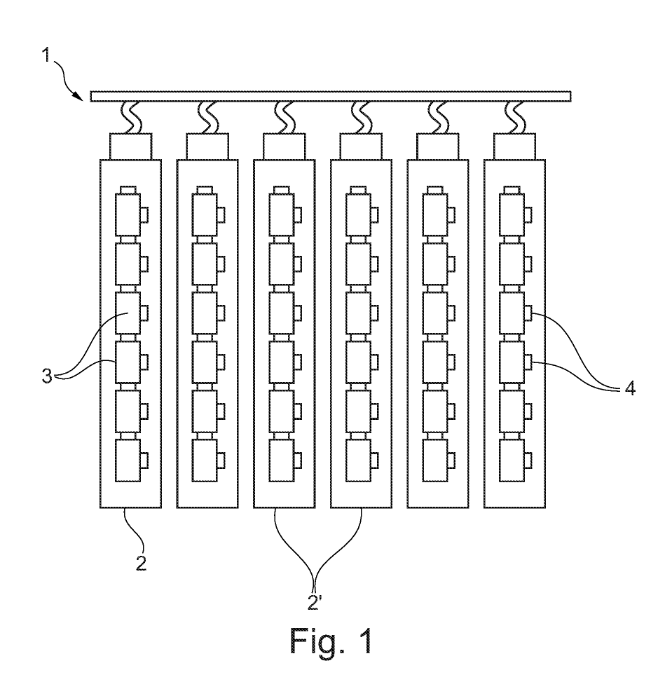

FIG. 1 illustrates an embodiment of the battery arrangement 1. The battery arrangement 1 comprises a plurality of battery cells 2, 2′ that are electrically connected to one another. Each of the battery cells 2 comprises a plurality of individual electrochemical cells 3. Each of the battery cells 2 is thermally insulated from the further battery cells 2′ of the plurality of battery cells 2, 2′ of the battery arrangement 1. Each of the individual electrochemical cells 3 of the battery cells 2, 2′ comprises a monitoring device 4. The monitoring device 4 is configured so as to electrically disconnect the battery cell 2 from the further battery cells 2′ if at least one measured value that is to be monitored by the monitoring device 4 lies outside a predetermined value range. Although the battery cells 2, 2′ of the battery arrangement 1 in the illustrated embodiment of the battery arrangement 1 are arranged relatively close to one another, the spacing of the battery cells 2, 2′ can be almost arbitrarily large and is essentially only limited by the dimensions by way of example of a vehicle in which the battery arrangement 1 is used. It is preferred that the spacings between the battery cells 2, 2′ are however selected in such a manner that the loss of power between the individual battery cells 2, 2′ of the battery arrangement 1 is not too large. However, it is preferred that each of the battery cells 2, 2′ is arranged as a stand-alone constructive element that by way of example is to be seen as having its own housing or the like and is arranged spaced apart from the further battery cells 2, 2′. As best as possible a thermal insulation of the battery cells 2, 2′ of the battery arrangement with respect to one another is achieved by preferably spacing the battery cells apart with respect to one another. In the case of a thermal runaway, in other words a burn-out of one or multiple individual electrochemical cells 3 of a battery cell 2, the further battery cells 2′ are not damaged. The monitoring device 4 is configured by way of example so as to ascertain an increase in temperature of the individual electrochemical cell 3. The remaining battery cells 2′ of the battery arrangement 1 can still be used by electrically disconnecting the damaged battery cell 2 from the further battery cells 2′ of the battery arrangement 1. If the battery arrangement is subdivided into many small battery cells 2, 2′, the effect on the battery arrangement 1 as a result of the power loss of one or some battery cells 2 is also kept relatively small.

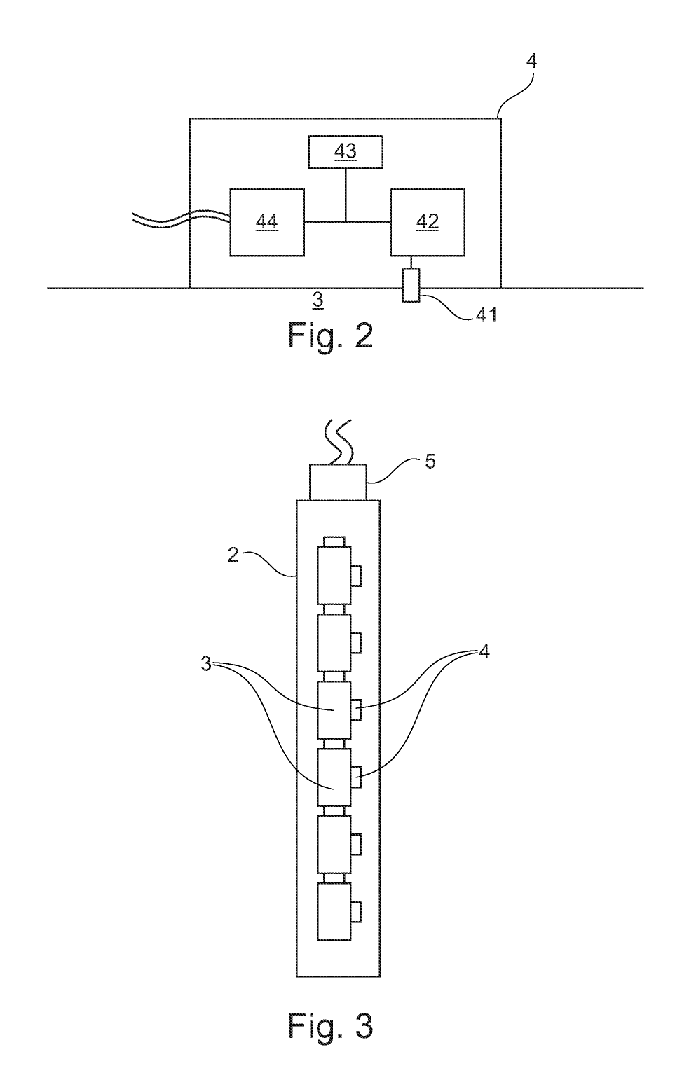

FIG. 2 illustrates an embodiment of a monitoring device 4 on an individual electrochemical cell 3. In the illustrated embodiment, the monitoring device 4 comprises an ascertaining unit 41, an evaluating device 42, a storage device 43 and a communications device 44. The ascertaining unit 41, the evaluating device 42, the storage device 43 and the communications device 44 are connected to one another. The ascertaining unit 41 comprises the measured value that is to be ascertained, by way of example the temperature of the individual electrochemical cell 3, by a temperature sensor (not illustrated in detail) and transmits the measured value to the evaluating device 42. The evaluating device 42 compares the measured values that are transmitted by the ascertaining unit 41 with a threshold value that is stored in the storage device 43 or a value range, in other words an upper threshold value and a lower threshold value. The evaluating device 42 determines whether the measured temperature value lies below or above the threshold value. An increase in temperature of the individual electrochemical cell can possibly indicate a thermal runaway of the individual electrochemical cell. If it has been determined by the evaluating device 42 that the temperature of the individual electrochemical cell 3 is too high, in other words lies above the stored threshold value, a signal by way of example a current pulse is supplied by way of the communications device 44 to a disconnecting device, by way of example a semiconductor constructive element, such as by way of example a MOSFET, or a transistor or the like. As a consequence, the entire battery cell 2 is electrically disconnected from the further battery cells 2′ of the battery arrangement 1, as is illustrated in FIG. 1.

FIG. 3 illustrates an embodiment of a battery cell 2. The battery cell 2 comprises a plurality of individual electrochemical cells 3 that are connected in series. The individual electrochemical cells 3 comprise in each case a monitoring device 4. In order by way of example to ascertain the voltage of the battery cell 2 or the current that prevails at the battery cell 2, the battery cell 2 comprises a further monitoring device 5. The further monitoring device 5 comprises by way of example a voltage sensor and/or a current sensor by which, it is possible to ascertain the voltage of the battery cell or the current that prevails at the battery cell. A change in voltage or performance can by way of example indicate a defect in one or multiple of the individual electrochemical cells of the battery cell, by way of example owing to the start of a thermal runaway. By way of example, the entire battery cell 2 can be electrically disconnected from the further battery cells 2′ of the battery arrangement 1 as is illustrated by way of example in FIG. 1 if the change in voltage or performance should exceed a critical value. For this purpose, the further monitoring device 5 can comprise by way of example a storage device in which one or multiple threshold values are stored and the values are compared in an evaluating device to the ascertained current or voltage values.

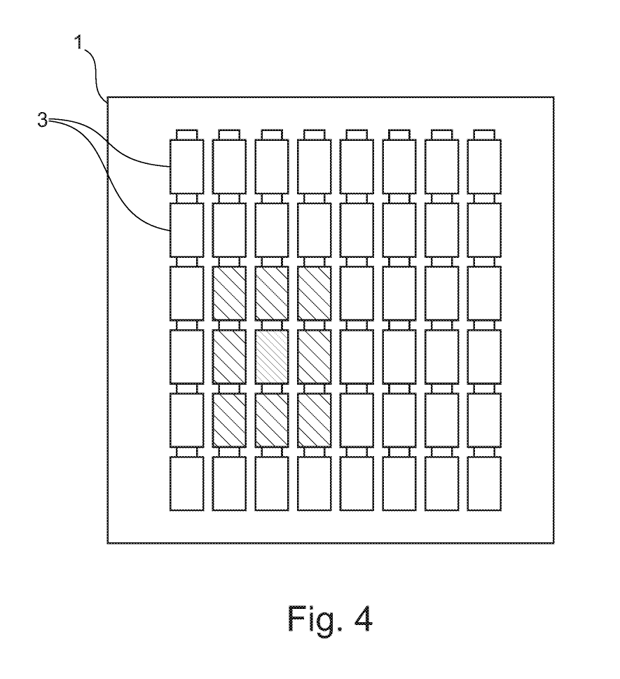

FIG. 4 illustrates the construction of a conventional battery arrangement 1. In the case of a conventional battery arrangement 1, all individual electrochemical cells or secondary elements 3 are packed in a common housing. In the case of a thermal runaway of one or multiple individual electrochemical cells 3 owing to a defect (hatched area), the surrounding individual cells 3 (hatched area) are also simultaneously adversely affected and possibly become damaged. In certain circumstances, a burn-out of a single individual cell can damage so many surrounding further individual cells that the entire battery arrangement can no longer be used. This can be prevented to a large extent by the battery arrangement that is described in this application.

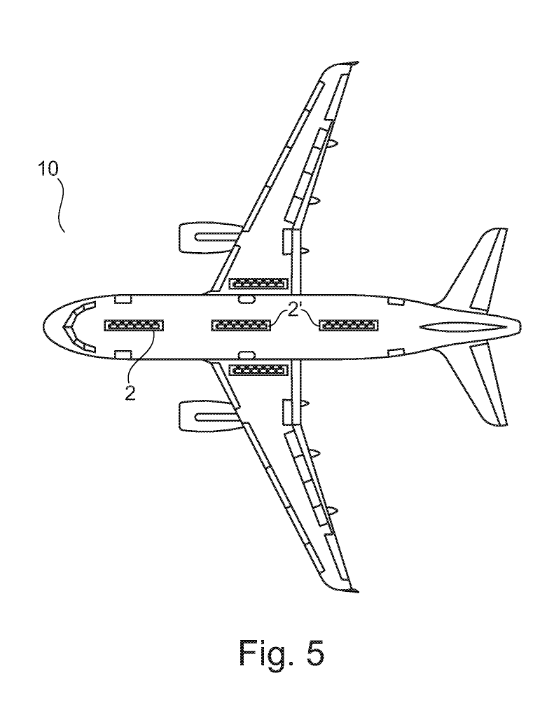

FIG. 5 illustrates an aircraft 10 having an embodiment of the battery arrangement. The battery arrangement comprises a plurality of battery cells 2, 2′. The battery cells 2, 2′ are arranged in different regions of the aircraft, by way of example in the fuselage and the wings. As effective as possible a thermal insulation of the individual battery cells 2, 2′ with respect to one another is achieved by spacing the battery cells 2, 2′ apart with respect to one another. In the case of a defect of one or multiple individual electrochemical cells of a battery arrangement having a possibly connected thermal runaway, this battery cell 2 can be electrically disconnected from the further battery cells 2′. The further battery cells 2′ are furthermore available and can be further used with a slightly reduced performance. A total failure of the complete battery arrangement is consequently prevented as much as possible.

Although the disclosure herein above all is illustrated and described with reference to specific embodiments, it should be understood by those with knowledge of the subject matter that numerous changes in relation to the design and details can be made without departing from the nature and scope of the disclosure herein, as is defined in the attached claims. The scope of the disclosure herein is consequently determined by the attached claims and it is therefore intended that all changes that fall within the literal sense or the equivalent scope of the claims are included.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

1 Battery arrangement

2, 2′ Battery cell

3 Individual electrochemical cell

4 Monitoring device

41 Ascertaining unit

42 Evaluating device

43 Storage device

44 Communications device

5 Further monitoring device

10 Aircraft

1. A battery arrangement, comprising:
a plurality of battery cells that are electrically connected to one another;
wherein each of the battery cells comprises a plurality of individual electrochemical cells;
wherein each of the battery cells is thermally insulated from further battery cells of the plurality of battery cells;
wherein each of the individual electrochemical cells comprises a monitoring device; and
wherein each monitoring device is configured to electrically disconnect the battery cell from the further battery cells if at least one measured value that is to be monitored by the monitoring device lies outside a predetermined value range.

2. The battery arrangement as claimed in claim 1, wherein the battery cells are spaced apart with respect to one another.

3. The battery arrangement as claimed in claim 1, wherein the monitoring device comprises an ascertaining unit that is configured to ascertain the measured value that is to be monitored and relates to the individual electrochemical cell.

4. The battery arrangement as claimed in claim 1, wherein the monitoring device comprises an evaluating device configured to receive the measured value that is ascertained by the ascertaining unit and determines whether the measured value lies outside the predetermined value range.

5. The battery arrangement as claimed in claim 3, wherein the ascertaining unit comprises at least one temperature sensor for ascertaining the temperature of the individual electrochemical cells.

6. The battery arrangement as claimed in claim 5, wherein the monitoring device is configured to electrically disconnect the battery cell from the further battery cells of the plurality of battery cells if the temperature of the individual electrochemical cell that is ascertained by the temperature sensor lies outside a predetermined temperature range.

7. The battery arrangement as claimed in claim 6, wherein the monitoring device is configured so as to electrically disconnect the battery cell from the further battery cells if the ascertained temperature of the individual electrochemical cell lies above a predetermined temperature value.

8. The battery arrangement as claimed in claim 3, wherein each of the battery cells comprises at least one further ascertaining unit that comprises a voltage sensor for ascertaining the voltage that prevails at the battery cell.

9. The battery arrangement as claimed in claim 8, wherein at least one further ascertaining unit comprises a current sensor for ascertaining the current that prevails at the battery cell.

10. The battery arrangement as claimed in claim 9, wherein the individual electrochemical cell is a lithium rechargeable battery.

11. The battery arrangement as claimed in claim 10, wherein the lithium rechargeable battery is a lithium sulphur rechargeable battery.

12. A vehicle comprising at least one battery arrangement as claimed in claim 11.

13. The vehicle as claimed in claim 12, wherein the plurality of battery cells of the at least one battery arrangement is arranged distributed spaced apart with respect to one another over the vehicle.

14. The vehicle as claimed in claim 12, wherein the vehicle is a flying apparatus.

15. The vehicle as claimed in claim 14, wherein the flying apparatus is an unmanned aircraft.

16. The vehicle as claimed in claim 14, wherein the flying apparatus is a high altitude platform or station, or wherein the flying apparatus is a pseudo-satellite.
